(19) United States
(12) Patent Application Publication
(10) Pub. No.: US 2025/0301497 A1
(43) Pub. Date: Sep. 25, 2025

(54) MANAGEMENT OF NON-PRIMARY CHANNEL ACCESS MODES AND SCHEDULING POLICIES IN WIRELESS COMMUNICATION SYSTEMS

(71) Applicant: Intel Corporation, Santa Clara, CA (US)

(72) Inventors: Laurent Cariou, Milizac (FR); Thomas J. Kenney, Portland, OR (US); Minyoung Park, San Ramon, CA (US)

(73) Assignee: Intel Corporation, Santa Clara, CA (US)

(21) Appl. No.: 19/232,236

(22) Filed: Jun. 9, 2025

Related U.S. Application Data
(60) Provisional application No. 63/659,027, filed on Jun. 12, 2024.
(60) Provisional application No. 63/687,529, filed on Aug. 27, 2024.

(51) Int. Cl. H04W 74/00; H04L 1/00; H04W 74/0808

(52) U.S. Cl. CPC H04W 74/004; H04L 1/0003; H04W 74/0808

(57) ABSTRACT

This disclosure describes systems, methods, and devices related to enhanced NPCA primary channel. A device may receive, from an access point (AP), a trigger frame on a non-primary channel associated with a non-primary channel access (NPCA) mode of operation, the trigger frame comprising resource unit (RU) allocations for uplink transmissions. The device may determine, based on the trigger frame, whether the device is scheduled for an uplink transmission on the non-primary channel. The device may transmit, using a resource unit allocated in the trigger frame, uplink data on the non-primary channel to the AP. The device may receive, from the AP, a block acknowledgment corresponding to the uplink transmission.

### CROSS-REFERENCE TO RELATED APPLICATIONS

This application claims the benefit of U.S. Provisional Application No. 63/687,529, filed Aug. 27, 2024, and U.S. Provisional Application No. 63/659,027, filed Jun. 12, 2024, the disclosures of which are incorporated herein by reference as if set forth in full.

### BACKGROUND

Modern wireless communication systems continue to evolve to support increasing data demands, device density, and spectrum complexity across various frequency bands. There is a need for improved techniques to manage channel access and optimize data transmission in dynamic and diverse wireless environments.

### BRIEF DESCRIPTION OF THE DRAWINGS

FIG. 1 is a network diagram illustrating an example network environment for enhanced NPCA primary channel, in accordance with one or more example embodiments of the present disclosure.

FIG. 2 depicts an illustrative schematic diagram for enhanced NPCA primary channel, in accordance with one or more example embodiments of the present disclosure.

FIG. 3 illustrates a flow diagram of a process for an illustrative enhanced NPCA primary channel system, in accordance with one or more example embodiments of the present disclosure.

FIG. 4 illustrates a functional diagram of an exemplary communication station that may be suitable for use as a user device, in accordance with one or more example embodiments of the present disclosure.

FIG. 5 illustrates a block diagram of an example machine upon which any of one or more techniques (e.g., methods) may be performed, in accordance with one or more example embodiments of the present disclosure.

FIG. 6 is a block diagram of a radio architecture in accordance with some examples.

FIG. 7 illustrates an example front-end module circuitry for use in the radio architecture of FIG. 6, in accordance with one or more example embodiments of the present disclosure.

FIG. 8 illustrates an example radio IC circuitry for use in the radio architecture of FIG. 6, in accordance with one or more example embodiments of the present disclosure.

FIG. 9 illustrates an example baseband processing circuitry for use in the radio architecture of FIG. 6, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

The concept of non primary channel access (NPCA) is proposed. Some access point (AP) vendors have been asking for a mode where there is only triggered access on the NPCA primary channel.

There are few design goals that need to be respected if it is to define such a mode. These design goals aim to ensure predictable and efficient operation of the NPCA system by aligning station behavior with access point scheduling capabilities. This coordination is particularly important in environments with high user density or limited channel availability, where maximizing spectrum utilization and minimizing contention are essential. For example, a properly designed NPCA mode may improve throughput in a stadium deployment by reducing idle listening and ensuring targeted scheduling.

Confidence on the station (STA) side that if it stays awake and transitions to the NPCA channel, it will be scheduled for transmission/reception or at least know very early on if it will be scheduled or not. Confidence on the STA side that the AP is aware of the buffer status of the STA and of a minimum knowledge of the rate selection, including number of spatial streams (NSS) and MCS for transmissions on the NPCA channel. This entails that STAs are not only aware of the possibility of upcoming transmission opportunities, but also that they can conserve energy by avoiding unnecessary channel monitoring. For instance, a smartphone may transition to an NPCA channel with the expectation that the AP has already accounted for its data backlog and link conditions, such as signal-to-noise ratio, and will initiate communication promptly or notify the STA of delays. This reduces both latency and power consumption.

In this disclosure, it is shown how such a mechanism should be defined. The mechanism includes the coordination of channel access policies, signaling strategies for timely STA feedback, and mapping of traffic conditions to scheduling decisions. This ensures that the NPCA system delivers both spectral efficiency and predictability of service. Additionally, techniques such as buffer status reports and channel sounding can be used to dynamically inform the AP of STA capabilities and readiness, further enabling intelligent decision-making in the NPCA context.

Example embodiments of the present disclosure relate to systems, methods, and devices for mode with no enhanced distributed channel access (EDCA) on NPCA primary channel.

In one embodiment, an enhanced NPCA primary channel system may define a mode where non-AP STAs are not allowed to use EDCA to access the medium, which means that they can only be triggered by the associated AP (using uplink (UL) Trigger-based access). This mode enhances channel efficiency by eliminating contention-based transmissions on the NPCA primary channel and instead relies on a scheduled mechanism wherein the AP initiates and controls uplink opportunities. For example, in a dense deployment such as a sports arena or a large conference center, this approach helps avoid uplink collisions and ensures predictable airtime allocation. This scheduling-based access facilitates better Quality of Service (QOS) for latency-sensitive applications like real-time gaming or augmented reality.

UL Trigger-based access refers to the uplink multi-user (UL MU) transmission mechanism that allows an AP to schedule and trigger simultaneous uplink transmissions from multiple stations (STAs) using orthogonal frequency division multiple access (OFDMA). The AP sends a Trigger Frame to schedule and initiate uplink transmissions from multiple STAs. The Trigger Frame allocates different resource units (RUs) of the OFDMA channel to different STAs for their uplink transmissions. This enables multiple STAs to transmit simultaneously on the uplink using different OFDMA RUs, improving overall network capacity and efficiency.

The STAs respond by transmitting their uplink data in the allocated RUs after receiving the Trigger Frame from the AP. UL Trigger-based access using OFDMA replaces the contention-based random access of legacy Wi-Fi, mitigating collisions in high-density deployments. The AP can then send a Block Ack to acknowledge the received uplink transmissions from the STAs. In summary, UL Trigger-based access is the OFDMA-based scheduled uplink transmission mechanism in 802.11ax, initiated by the AP's Trigger Frames, that enables efficient simultaneous uplink transmissions from multiple STAs.

It is proposed here that the AP can enable or disable this NPCA mode for its associated STAs.

It is proposed here that, whether this mode is enabled or disabled, as long as the AP supports NPCA, the STA is able to enable its use of NPCA or not (STA is in control whether it wants to use NPCA or not).

It is proposed here that, if an AP enables the mode of operation where STAs are not allowed to use UL EDCA to access medium on the NPCA channel.

Example embodiments of the present disclosure relate to systems, methods, and devices for WiFi8—non-primary channel access (NPCA) based on service periods.

In this disclosure, a scheduled secondary access system may define a similar NPCA, but where operation on the secondary channel is done based on pre-announced service periods.

In one embodiment, a scheduled secondary access system may define NPCA based on service periods and outline the rules for these service periods and the configuration. It outlines the use and tear down of these service periods and the signaling to enable in addition to the signaling with neighboring APs of the use of these service periods.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

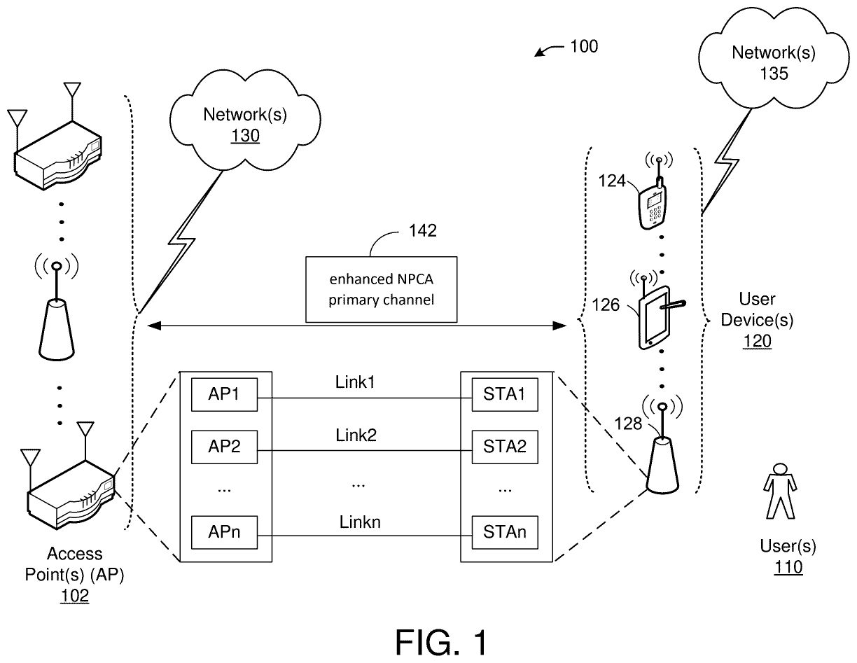

FIG. 1 is a network diagram illustrating an example network environment of enhanced NPCA primary channel, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

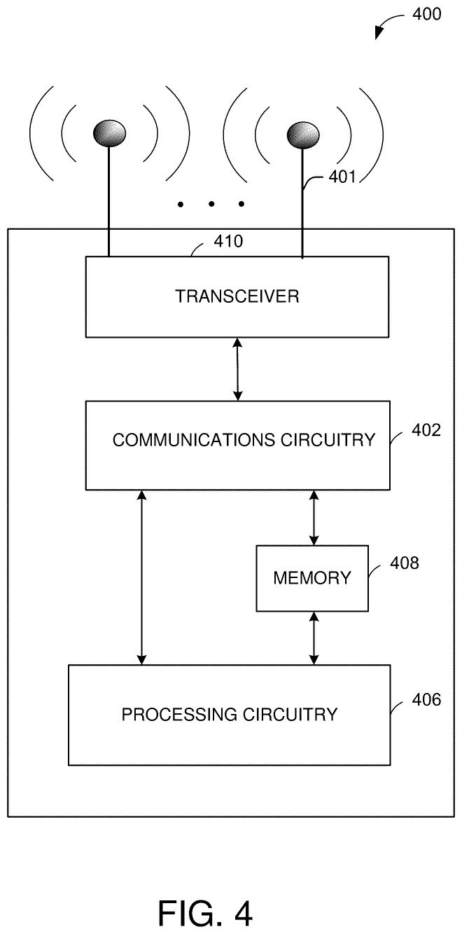

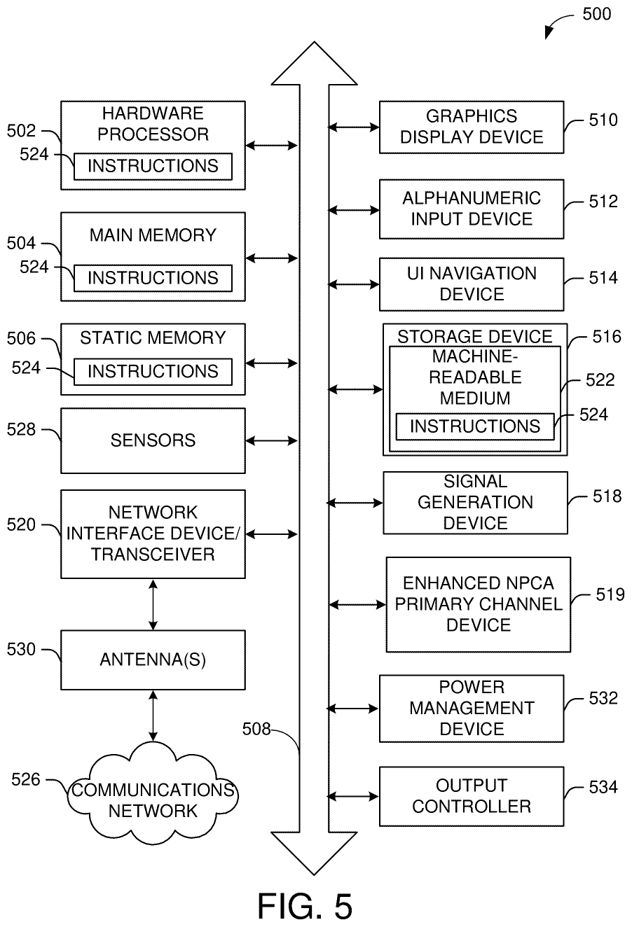

In some embodiments, the user devices 120 and the AP 102 may include one or more computer systems similar to that of the functional diagram of FIG. 4 and/or the example machine/system of FIG. 5.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an enhanced NPCA primary channel 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

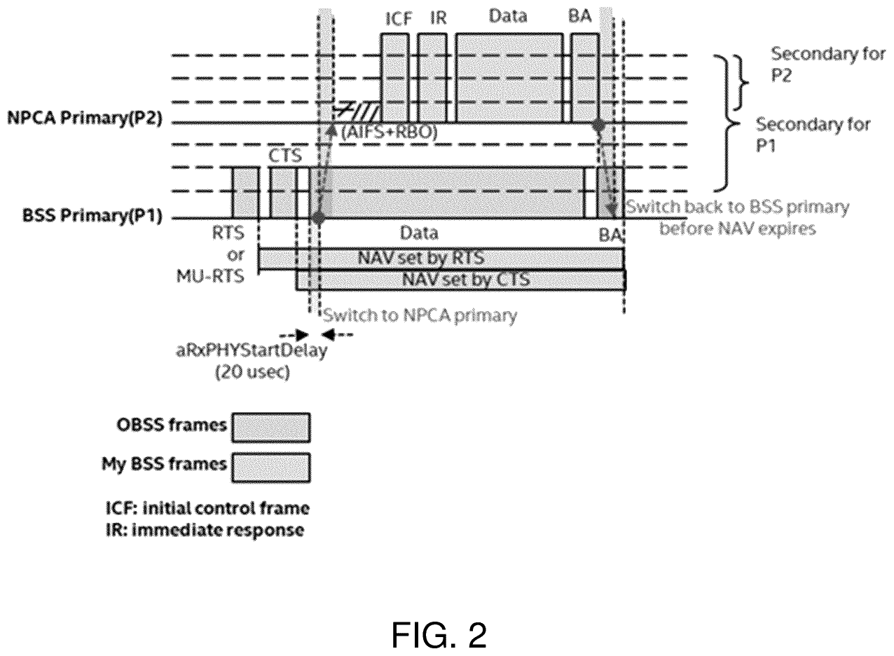

FIG. 2 depicts an illustrative schematic diagram for enhanced NPCA primary channel, in accordance with one or more example embodiments of the present disclosure.

The concept of Non Primary Channel Access (NPCA) is proposed, which is illustrated in FIG. 2.

NPCA is a feature that allows APs and client devices to utilize the 6 GHz band (or other bands) more efficiently by transmitting on multiple channels simultaneously. NPCA enables an AP to transmit data on a primary channel as well as one or more non-primary channels concurrently. This allows better utilization of the abundant 6 GHz spectrum by offloading traffic from the primary channel to non-primary channels.

Non-primary channels can be used for downlink transmissions only, while the primary channel handles uplink and management traffic. NPCA improves overall network capacity and throughput, especially in high-density environments with many clients. It mitigates channel contention and airtime congestion issues that can degrade Wi-Fi performance. The ability to leverage multiple channels simultaneously through NPCA is a key advantage over previous Wi-Fi generations, enabling better quality of experience for bandwidth-intensive applications like video streaming, online gaming, etc.

The “NPCA primary channel” may not be the main BSS primary channel but rather a designated downlink-only channel within the NPCA scheme, used by APs to efficiently schedule client transmissions. It may be considered as the “lead” channel among the non-primary ones under NPCA, optimized for managed, high-efficiency downlink delivery.

Some AP vendors have been asking for a mode where there is only triggered access on the NPCA primary channel.

There are a few design goals needed to be respected if such mode is to be defined.

Confidence on the STA side that if it stays awake and transitions to the NPCA channel, it will be scheduled for transmission/reception or at least know very early on if it will be scheduled or not.

Confidence on the STA side that the AP is aware of the buffer status of the STA and of a minimum knowledge of the rate selection (NSS and MCS) for transmissions on the NPCA channel.

In this disclosure, it is shown how such a mechanism should be defined.

It is proposed here to define a mode where non-AP STAs are not allowed to use EDCA to access the medium, which means that they can only be triggered by the associated AP (using UL Trigger-based access).

It is proposed here that the AP can enable or disable this NPCA mode for its associated STAs.

Which means that the AP will indicate, along with the capability information that it supports NPCA, that when NPCA is used by the STA, it has to be under this mode (without UL EDCA) or not.

It is proposed here that the AP can dynamically move in and out of this NPCA mode, meaning disable or enable the mode where UL EDCA is not allowed. This can be done by having this field be indicated in the UHR operation element of the AP and having the ability to change this field while operating (for instance through the critical update procedure). Or this can be done also through a specific update procedure with dedicated elements and frames that are sent to the associated STAs.

It is proposed here, whether this mode is enabled or disabled, as long as the AP supports NPCA, the STA is able to enable its use of NPCA or not (STA is in control whether it wants to use NPCA or not).

In one or more embodiments, it is proposed here, if an AP enables the mode of operation where STAs are not allowed to use UL EDCA to access medium on the NPCA channel:

The AP shall keep track of the buffer status of each associated STA operating with NPCA.

The AP shall schedule to transmit a BSRP trigger frame scheduling each associated STA operating with NPCA regularly.

A field sent by the non-AP STA that indicates the time interval between 2 BSRP trigger frame that the STA will need to achieve is defined.

Unless the STA has an SCS traffic that has been established with the AP and that indicates the traffic pattern of the STA in UL, and the AP has to commit to schedule the STA for transmission using UL TB PPDU to ensure that the STA will be able to transmit all its frames as needed.

When the AP transitions to the NPCA channel based on the NPCA conditions, and likely associated STAs that currently operate with NPCA (calling them NPCA STAs here for simplicity) also transition to the NPCA channels, the following is proposed:

When the AP accesses the medium on the NPCA channel, the AP shall include in the Initial control frame (first frame sent on the NPCA channel within the gained TxOP) all the STAs that will be scheduled for transmission or reception during the entire TxOP.

If the ICF is a BSRP Trigger frame, the BSRP Trigger frame shall include a User Info field for each NPCA STA that will be scheduled during the TxOP both in DL and in UL (the ICF may also be another frame, such as an MU-RTS trigger frame, of an MU-BAR or a new ICF control frame.

The NPCA STAs then respond with an ICR frame that is either a QoS Null frame with the BSR information, or a Multi-STA BA frame that includes possibly other information, for link adaptation for instance.

The NPCA STAs that receive the ICF frame from their associated AP on the NPCA channel, but are not identified in a user info field in the ICF frame, shall consider that they will not be scheduled during the TxOP and can therefore go back to the BSS primary channel and go in doze state until the end of the NPCA window (corresponding to the OBSS TxOP on the BSS primary channel—the detection of which caused the STA to transition to NPCA primary channel)

It can also be mandated that the AP shall always query Buffer Status report from all NPCA STAs at the beginning of each TxOP on the NPCA channel, and that, once the NPCA STAs have responded by sending their BSR status in the ICR transmitted in UL TB PPDU, then the following frame sent by the AP will determine which STAs are scheduled for transmission/reception during the TxOP, meaning that if a STA is not addressed or scheduled by a user info field in the following frame, then the STA goes back to the BSS Primary channel and may go to doze state until the end of the OBSS TxOP on the BSS primary channel.

In order to have a better link adaptation on the NPCA channel, it is proposed that, if the STA and the AP support fast link adaptation with information provided in ICF/ICR exchange, then it is proposed to mandate that the AP shall always send to the STA on the NPCA channel an ICF that will allow the STA to send fast link adaptation feedback in the ICR frame sent in response to the ICF frame, and along with the BSR status of the STA. If the STA or the AP does not support fast link adaptation, then the AP shall/should use TxOP Sharing mode 1 to schedule the STA for UL transmission (UL SU PPDU transmission in response to TxS MU-RTS trigger frame), so that it is the STA that is managing the rate selection for UL transmissions on NPCA channel.

The proposal in this disclosure is to define NPCA based on service periods as follows:

The AP announces a periodic service period, for instance with a Broadcast TWT element, and provides signaling in this announcement defining the operation to be on a non-primary channel(s) during the service periods (or alternatively outside of the service periods).

In the definition of this operation on the non-primary channels the following parameters would be potentially included:

A bandwidth and a set of channels, which can be signaled through a bandwidth (BW) field or by a Channel Number field by indicating the channel number and possibly operating class that corresponds to a specific BW.

The non-primary temporary primary channel (primary channel corresponding to operating on NP during the service periods—can also be called temporary primary channel or SP-based primary channel, . . . ).

The BW can be within the BW of the BSS or could be outside of the BSS BW. Or have a portion of the total BW outside the BSS BW.

In one or more embodiments, it is also proposed to include a specific mode where the BW within the service period is smaller than the BSS BW and the primary channel within the service period is the same as the primary channel of the BSS. In that case, the BW is limited during operations within the Service Period.

These parameters can be included in a Broadcast TWT element in the beacon frames transmitted by the AP, or as a separate element, or any other means.

The AP can decide to stop advertising such periodic service period or change the non-primary BW by announcing a tear down, or a parameter change. In both cases, it is proposed that the AP shall signal ahead of time that a change and what change will happen and indicate in that signaling when this change will occur. It could also include a period of time this will not be offered, or a time when this operation will resume.

During the Service period, all STAs associated with the AP and the AP itself will transition to the non-primary operating channels.

In one or more embodiments, it is proposed to define a transition delay for STAs and APs before being able to operate on the new channel. Such a delay is advertised by the AP and the STAs. The AP and the STAs will stay on the new channel until the end of the service period and will then transition back to the original primary channel.

For the mode where only the BW changes and not the primary channel, there will likely be no transition delay.

In one or more embodiments, after the transition delay, it is proposed that STAs and APs can perform EDCA channel access as defined for regular NPCA. There can be a mode which is fully triggered and where only the AP is allowed to access the medium and a mode where EDCA channel access is possible for the AP and the STAs that transitioned. The parameters for EDCA can be the same as the parameters on the BSS primary channel, or could be different (in which case, these parameters will need to be advertised by the AP). It is proposed that the STA and APs can draw a new BO on the new channel every time using the EDCA parameters and taking into account the CW (contention window) of the BSS primary channel.

In order for such mode to be usable, it is needed to allow coordination between neighboring APs in order to synchronize their schedules and ensure for instance that during a same service period, one AP will operate on a portion of the BSS BW, and the other AP will operate on the second portion of the BSS BW (BSS BW being the same for both APs in this example). It is therefore proposed to have Coordination Request and Response frames that can be exchanged between 2 APs in order to exchange the periodic service periods and the operating BW within the service periods, for each AP. If the coordination is successful, the Response frame indicates a status code of Accept, and following that, the 2 APs will advertise periodic service periods with specific coordinated BW operation of the 2 APs respectfully.

It is understood that the above descriptions are for the purposes of illustration and are not meant to be limiting.

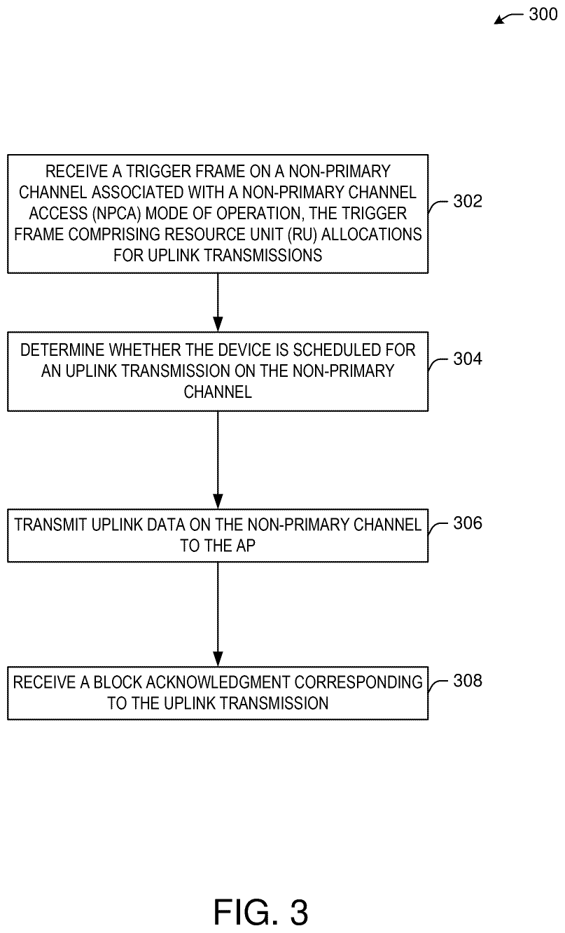

FIG. 3 illustrates a flow diagram of illustrative process 300 for an enhanced NPCA primary channel system, in accordance with one or more example embodiments of the present disclosure.

At block 302, a device (e.g., the user device(s) 120 and/or the AP 102 of FIG. 1 and/or the enhanced NPCA primary channel device 519 of FIG. 5) may receive a trigger frame on a non-primary channel associated with a non-primary channel access (NPCA) mode of operation, the trigger frame comprising resource unit (RU) allocations for uplink transmissions.

At block 304, the device may determine whether the device is scheduled for an uplink transmission on the non-primary channel.

At block 306, the device may Transmit uplink data on the non-primary channel to the AP.

At block 308, the device may receive a block acknowledgment corresponding to the uplink transmission.

The device may refrain from performing EDCA on the non-primary channel when the NPCA mode of operation is enabled. The device may determine whether to enable or disable the use of NPCA based on a local control setting. The non-primary channel may be used exclusively for downlink transmissions unless the AP transmits a trigger frame to permit uplink access. The uplink data transmitted in the resource unit may comprise latency-sensitive traffic. The trigger frame may indicate an MCS and NSS associated with the allocated resource unit. The device may monitor the NPCA channel only upon receipt of a wake-up signal or scheduled transmission indication from the AP. The device may provide buffer status information to the AP prior to receiving the trigger frame. The non-primary channel may operate within the 6 GHz band in accordance with the IEEE 802.11ax or 802.11be standard. The AP may selectively enable or disable the NPCA mode for individual associated STAs, and the device may dynamically adapt to the AP's configuration.

It is understood that the above descriptions are for the purposes of illustration and are not meant to be limiting.

FIG. 4 shows a functional diagram of an exemplary communication station 400, in accordance with one or more example embodiments of the present disclosure. In one embodiment, FIG. 4 illustrates a functional block diagram of a communication station that may be suitable for use as an AP 102 (FIG. 1) or a user device 120 (FIG. 1) in accordance with some embodiments. The communication station 400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 400 may include communications circuitry 402 and a transceiver 410 for transmitting and receiving signals to and from other communication stations using one or more antennas 401. The communications circuitry 402 may include circuitry that can operate the physical layer (PHY) communications and/or medium access control (MAC) communications for controlling access to the wireless medium, and/or any other communications layers for transmitting and receiving signals. The communication station 400 may also include processing circuitry 406 and memory 408 arranged to perform the operations described herein. In some embodiments, the communications circuitry 402 and the processing circuitry 406 may be configured to perform operations detailed in the above figures, diagrams, and flows.

In accordance with some embodiments, the communications circuitry 402 may be arranged to contend for a wireless medium and configure frames or packets for communicating over the wireless medium. The communications circuitry 402 may be arranged to transmit and receive signals. The communications circuitry 402 may also include circuitry for modulation/demodulation, upconversion/downconversion, filtering, amplification, etc. In some embodiments, the processing circuitry 406 of the communication station 400 may include one or more processors. In other embodiments, two or more antennas 401 may be coupled to the communications circuitry 402 arranged for sending and receiving signals. The memory 408 may store information for configuring the processing circuitry 406 to perform operations for configuring and transmitting message frames and performing the various operations described herein. The memory 408 may include any type of memory, including non-transitory memory, for storing information in a form readable by a machine (e.g., a computer). For example, the memory 408 may include a computer-readable storage device, read-only memory (ROM), random-access memory (RAM), magnetic disk storage media, optical storage media, flash-memory devices and other storage devices and media.

In some embodiments, the communication station 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 400 may include one or more antennas 401. The antennas 401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 400 may include one or more of a keyboard, a display, a non-volatile memory port, multiple antennas, a graphics processor, an application processor, speakers, and other mobile device elements. The display may be an LCD screen including a touch screen.

Although the communication station 400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 400 may include one or more processors and may be configured with instructions stored on a computer-readable storage device.

FIG. 5 illustrates a block diagram of an example of a machine 500 or system upon which any one or more of the techniques (e.g., methodologies) discussed herein may be performed. In other embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environments. The machine 500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, alphanumeric input device 512, and UI navigation device 514 may be a touch screen display. The machine 500 may additionally include a storage device (i.e., drive unit) 516, a signal generation device 518 (e.g., a speaker), an enhanced NPCA primary channel device 519, a network interface device/transceiver 520 coupled to antenna(s) 530, and one or more sensors 528, such as a global positioning system (GPS) sensor, a compass, an accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 502 for generation and processing of the baseband signals and for controlling operations of the main memory 504, the storage device 516, and/or the enhanced NPCA primary channel device 519. The baseband processor may be provided on a single radio card, a single chip, or an integrated circuit (IC).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In an example, one or any combination of the hardware processor 502, the main memory 504, the static memory 506, or the storage device 516 may constitute machine-readable media.

The enhanced NPCA primary channel device 519 may carry out or perform any of the operations and processes (e.g., process 300) described and shown above.

It is understood that the above are only a subset of what the enhanced NPCA primary channel device 519 may be configured to perform and that other functions included throughout this disclosure may also be performed by the enhanced NPCA primary channel device 519.

While the machine-readable medium 522 is illustrated as a single medium, the term “machine-readable medium” may include a single medium or multiple media (e.g., a centralized or distributed database, and/or associated caches and servers) configured to store the one or more instructions 524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas to connect to the communications network 526. In an example, the network interface device/transceiver 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

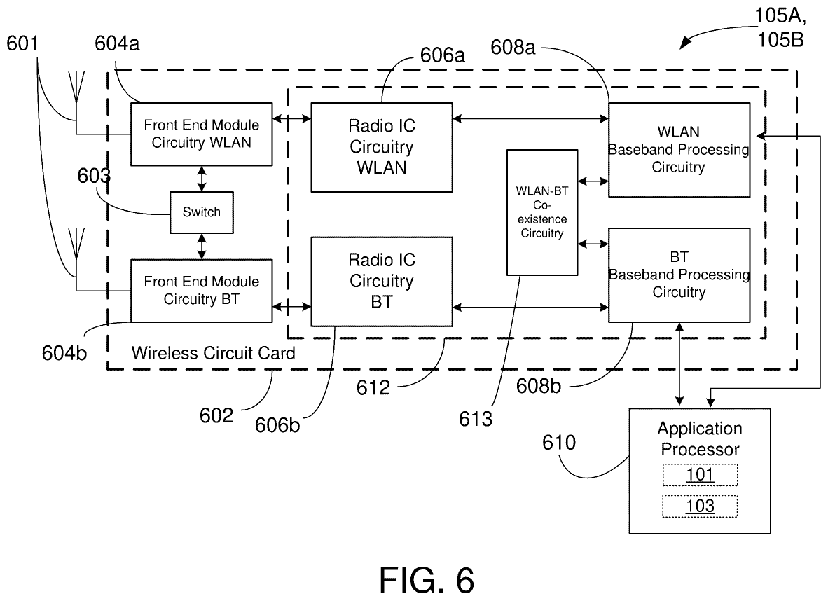

FIG. 6 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 604a-b, radio IC circuitry 606a-b and baseband processing circuitry 608a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 604a-b may include a WLAN or Wi-Fi FEM circuitry 604a and a Bluetooth (BT) FEM circuitry 604b. The WLAN FEM circuitry 604a may include a receive signal path comprising circuitry configured to operate on WLAN RF signals received from one or more antennas 601, to amplify the received signals and to provide the amplified versions of the received signals to the WLAN radio IC circuitry 606a for further processing. The BT FEM circuitry 604b may include a receive signal path which may include circuitry configured to operate on BT RF signals received from one or more antennas 601, to amplify the received signals and to provide the amplified versions of the received signals to the BT radio IC circuitry 606b for further processing. FEM circuitry 604a may also include a transmit signal path which may include circuitry configured to amplify WLAN signals provided by the radio IC circuitry 606a for wireless transmission by one or more of the antennas 601. In addition, FEM circuitry 604b may also include a transmit signal path which may include circuitry configured to amplify BT signals provided by the radio IC circuitry 606b for wireless transmission by the one or more antennas. In the embodiment of FIG. 6, although FEM 604a and FEM 604b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 606a-b as shown may include WLAN radio IC circuitry 606a and BT radio IC circuitry 606b. The WLAN radio IC circuitry 606a may include a receive signal path which may include circuitry to down-convert WLAN RF signals received from the FEM circuitry 604a and provide baseband signals to WLAN baseband processing circuitry 608a. BT radio IC circuitry 606b may in turn include a receive signal path which may include circuitry to down-convert BT RF signals received from the FEM circuitry 604b and provide baseband signals to BT baseband processing circuitry 608b. WLAN radio IC circuitry 606a may also include a transmit signal path which may include circuitry to up-convert WLAN baseband signals provided by the WLAN baseband processing circuitry 608a and provide WLAN RF output signals to the FEM circuitry 604a for subsequent wireless transmission by the one or more antennas 601. BT radio IC circuitry 606b may also include a transmit signal path which may include circuitry to up-convert BT baseband signals provided by the BT baseband processing circuitry 608b and provide BT RF output signals to the FEM circuitry 604b for subsequent wireless transmission by the one or more antennas 601. In the embodiment of FIG. 6, although radio IC circuitries 606a and 606b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 608a-b may include a WLAN baseband processing circuitry 608a and a BT baseband processing circuitry 608b. The WLAN baseband processing circuitry 608a may include a memory, such as, for example, a set of RAM arrays in a Fast Fourier Transform or Inverse Fast Fourier Transform block (not shown) of the WLAN baseband processing circuitry 608a. Each of the WLAN baseband circuitry 608a and the BT baseband circuitry 608b may further include one or more processors and control logic to process the signals received from the corresponding WLAN or BT receive signal path of the radio IC circuitry 606a-b, and to also generate corresponding WLAN or BT baseband signals for the transmit signal path of the radio IC circuitry 606a-b. Each of the baseband processing circuitries 608a and 608b may further include physical layer (PHY) and medium access control layer (MAC) circuitry, and may further interface with a device for generation and processing of the baseband signals and for controlling operations of the radio IC circuitry 606a-b.

Referring still to FIG. 6, according to the shown embodiment, WLAN-BT coexistence circuitry 613 may include logic providing an interface between the WLAN baseband circuitry 608a and the BT baseband circuitry 608b to enable use cases requiring WLAN and BT coexistence. In addition, a switch 603 may be provided between the WLAN FEM circuitry 604a and the BT FEM circuitry 604b to allow switching between the WLAN and BT radios according to application needs. In addition, although the antennas 601 are depicted as being respectively connected to the WLAN FEM circuitry 604a and the BT FEM circuitry 604b, embodiments include within their scope the sharing of one or more antennas as between the WLAN and BT FEMs, or the provision of more than one antenna connected to each of FEM 604a or 604b.

In some embodiments, the front-end module circuitry 604a-b, the radio IC circuitry 606a-b, and baseband processing circuitry 608a-b may be provided on a single radio card, such as wireless radio card 602. In some other embodiments, the one or more antennas 601, the FEM circuitry 604a-b and the radio IC circuitry 606a-b may be provided on a single radio card. In some other embodiments, the radio IC circuitry 606a-b and the baseband processing circuitry 608a-b may be provided on a single chip or integrated circuit (IC), such as IC 612.

In some embodiments, the wireless radio card 602 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 608b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHZ, 2.4 GHz, 5 GHZ, and bandwidths of about 2 MHz, 4 MHZ, 5 MHz, 5.5 MHz, 6 MHz, 8 MHz, 10 MHz, 20 MHz, 40 MHz, 80 MHZ (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

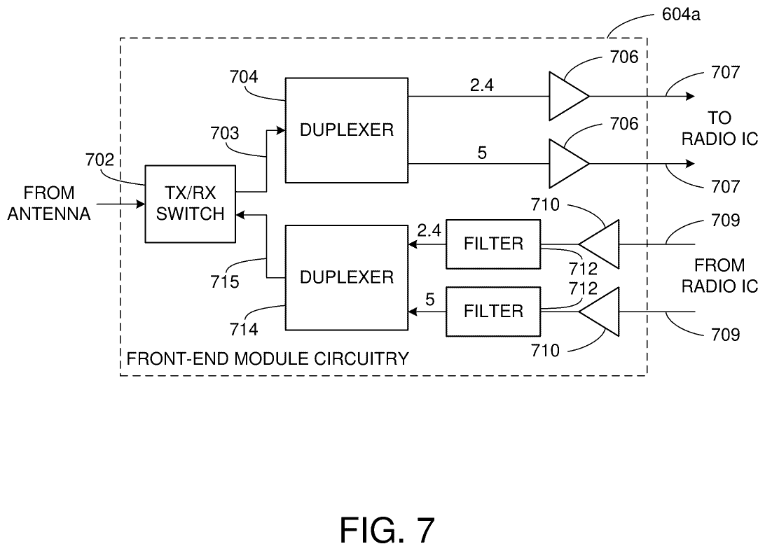

FIG. 7 illustrates WLAN FEM circuitry 604a in accordance with some embodiments. Although the example of FIG. 7 is described in conjunction with the WLAN FEM circuitry 604a, the example of FIG. 7 may be described in conjunction with the example BT FEM circuitry 604b (FIG. 6), although other circuitry configurations may also be suitable.

In some embodiments, the FEM circuitry 604a may include a TX/RX switch 702 to switch between transmit mode and receive mode operation. The FEM circuitry 604a may include a receive signal path and a transmit signal path. The receive signal path of the FEM circuitry 604a may include a low-noise amplifier (LNA) 706 to amplify received RF signals 703 and provide the amplified received RF signals 707 as an output (e.g., to the radio IC circuitry 606a-b (FIG. 6)). The transmit signal path of the circuitry 604a may include a power amplifier (PA) to amplify input RF signals 709 (e.g., provided by the radio IC circuitry 606a-b), and one or more filters 712, such as band-pass filters (BPFs), low-pass filters (LPFs) or other types of filters, to generate RF signals 715 for subsequent transmission (e.g., by one or more of the antennas 601 (FIG. 6)) via an example duplexer 714.

In some dual-mode embodiments for Wi-Fi communication, the FEM circuitry 604a may be configured to operate in either the 2.4 GHz frequency spectrum or the 5 GHz frequency spectrum. In these embodiments, the receive signal path of the FEM circuitry 604a may include a receive signal path duplexer 704 to separate the signals from each spectrum as well as provide a separate LNA 706 for each spectrum as shown. In these embodiments, the transmit signal path of the FEM circuitry 604a may also include a power amplifier 710 and a filter 712, such as a BPF, an LPF or another type of filter for each frequency spectrum and a transmit signal path duplexer 704 to provide the signals of one of the different spectrums onto a single transmit path for subsequent transmission by the one or more of the antennas 601 (FIG. 6). In some embodiments, BT communications may utilize the 2.4 GHz signal paths and may utilize the same FEM circuitry 604a as the one used for WLAN communications.

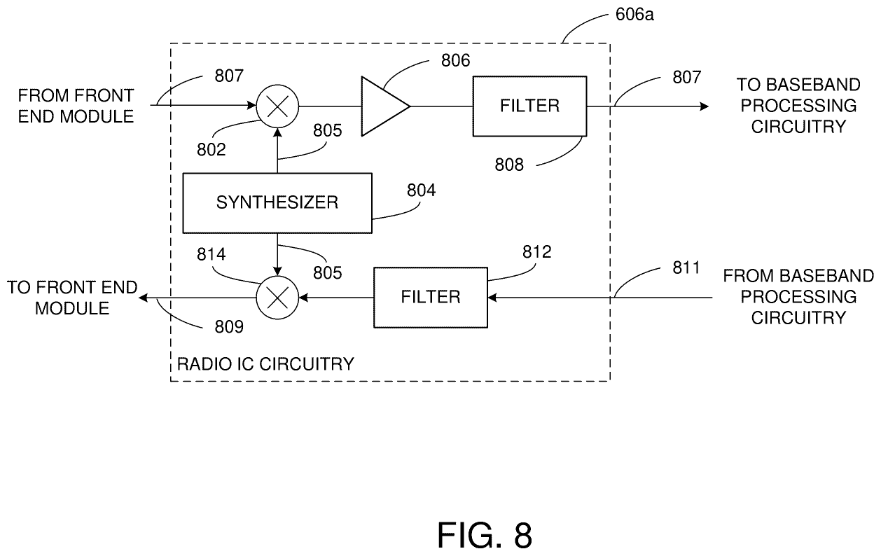

FIG. 8 illustrates radio IC circuitry 606a in accordance with some embodiments. The radio IC circuitry 606a is one example of circuitry that may be suitable for use as the WLAN or BT radio IC circuitry 606a/606b (FIG. 6), although other circuitry configurations may also be suitable. Alternatively, the example of FIG. 8 may be described in conjunction with the example BT radio IC circuitry 606b.

In some embodiments, the radio IC circuitry 606a may include a receive signal path and a transmit signal path. The receive signal path of the radio IC circuitry 606a may include at least mixer circuitry 802, such as, for example, down-conversion mixer circuitry, amplifier circuitry 806 and filter circuitry 808. The transmit signal path of the radio IC circuitry 606a may include at least filter circuitry 812 and mixer circuitry 814, such as, for example, up-conversion mixer circuitry. Radio IC circuitry 606a may also include synthesizer circuitry 804 for synthesizing a frequency 805 for use by the mixer circuitry 802 and the mixer circuitry 814. The mixer circuitry 802 and/or 814 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 8 illustrates only a simplified version of a radio IC circuitry, and may include, although not shown, embodiments where each of the depicted circuitries may include more than one component. For instance, mixer circuitry 814 may each include one or more mixers, and filter circuitries 808 and/or 812 may each include one or more filters, such as one or more BPFs and/or LPFs according to application needs. For example, when mixer circuitries are of the direct-conversion type, they may each include two or more mixers.

In some embodiments, mixer circuitry 802 may be configured to down-convert RF signals 707 received from the FEM circuitry 604a-b (FIG. 6) based on the synthesized frequency 805 provided by synthesizer circuitry 804. The amplifier circuitry 806 may be configured to amplify the down-converted signals and the filter circuitry 808 may include an LPF configured to remove unwanted signals from the down-converted signals to generate output baseband signals 807. Output baseband signals 807 may be provided to the baseband processing circuitry 608a-b (FIG. 6) for further processing. In some embodiments, the output baseband signals 807 may be zero-frequency baseband signals, although this is not a requirement. In some embodiments, mixer circuitry 802 may comprise passive mixers, although the scope of the embodiments is not limited in this respect.

In some embodiments, the mixer circuitry 814 may be configured to up-convert input baseband signals 811 based on the synthesized frequency 805 provided by the synthesizer circuitry 804 to generate RF output signals 709 for the FEM circuitry 604a-b. The baseband signals 811 may be provided by the baseband processing circuitry 608a-b and may be filtered by filter circuitry 812. The filter circuitry 812 may include an LPF or a BPF, although the scope of the embodiments is not limited in this respect.

In some embodiments, the mixer circuitry 802 and the mixer circuitry 814 may each include two or more mixers and may be arranged for quadrature down-conversion and/or up-conversion respectively with the help of synthesizer 804. In some embodiments, the mixer circuitry 802 and the mixer circuitry 814 may each include two or more mixers each configured for image rejection (e.g., Hartley image rejection). In some embodiments, the mixer circuitry 802 and the mixer circuitry 814 may be arranged for direct down-conversion and/or direct up-conversion, respectively. In some embodiments, the mixer circuitry 802 and the mixer circuitry 814 may be configured for super-heterodyne operation, although this is not a requirement.

Mixer circuitry 802 may comprise, according to one embodiment: quadrature passive mixers (e.g., for the in-phase (I) and quadrature phase (Q) paths). In such an embodiment, RF input signal 707 from FIG. 8 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 805 of synthesizer 804 (FIG. 8). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 707 (FIG. 7) may comprise a balanced signal, although the scope of the embodiments is not limited in this respect. The I and Q baseband output signals may be provided to low-noise amplifier, such as amplifier circuitry 806 (FIG. 8) or to filter circuitry 808 (FIG. 8).

In some embodiments, the output baseband signals 807 and the input baseband signals 811 may be analog baseband signals, although the scope of the embodiments is not limited in this respect. In some alternate embodiments, the output baseband signals 807 and the input baseband signals 811 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 804 may be a fractional-N synthesizer or a fractional N/N+1 synthesizer, although the scope of the embodiments is not limited in this respect as other types of frequency synthesizers may be suitable. For example, synthesizer circuitry 804 may be a delta-sigma synthesizer, a frequency multiplier, or a synthesizer comprising a phase-locked loop with a frequency divider. According to some embodiments, the synthesizer circuitry 804 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 804 may be provided by a voltage controlled oscillator (VCO), although that is not a requirement. A divider control input may further be provided by either the baseband processing circuitry 608a-b (FIG. 6) depending on the desired output frequency 805. In some embodiments, a divider control input (e.g., N) may be determined from a look-up table (e.g., within a Wi-Fi card) based on a channel number and a channel center frequency as determined or indicated by the example application processor 610. The application processor 610 may include, or otherwise be connected to, one of the example secure signal converter 101 or the example received signal converter 103 (e.g., depending on which device the example radio architecture is implemented in).

In some embodiments, synthesizer circuitry 804 may be configured to generate a carrier frequency as the output frequency 805, while in other embodiments, the output frequency 805 may be a fraction of the carrier frequency (e.g., one-half the carrier frequency, one-third the carrier frequency). In some embodiments, the output frequency 805 may be a LO frequency (fLO).

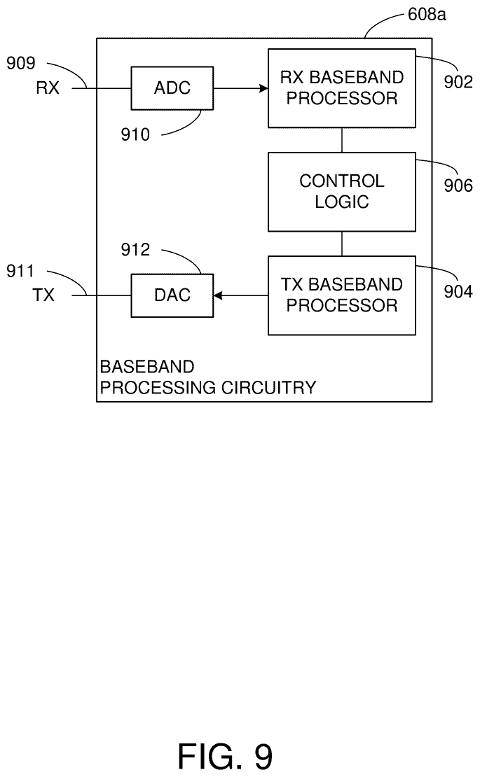

FIG. 9 illustrates a functional block diagram of baseband processing circuitry 608a in accordance with some embodiments. The baseband processing circuitry 608a is one example of circuitry that may be suitable for use as the baseband processing circuitry 608a (FIG. 6), although other circuitry configurations may also be suitable. Alternatively, the example of FIG. 8 may be used to implement the example BT baseband processing circuitry 608b of FIG. 6.

The baseband processing circuitry 608a may include a receive baseband processor (RX BBP) 902 for processing receive baseband signals 809 provided by the radio IC circuitry 606a-b (FIG. 6) and a transmit baseband processor (TX BBP) 904 for generating transmit baseband signals 811 for the radio IC circuitry 606a-b. The baseband processing circuitry 608a may also include control logic 906 for coordinating the operations of the baseband processing circuitry 608a.

In some embodiments (e.g., when analog baseband signals are exchanged between the baseband processing circuitry 608a-b and the radio IC circuitry 606a-b), the baseband processing circuitry 608a may include ADC 910 to convert analog baseband signals 909 received from the radio IC circuitry 606a-b to digital baseband signals for processing by the RX BBP 902. In these embodiments, the baseband processing circuitry 608a may also include DAC 912 to convert digital baseband signals from the TX BBP 904 to analog baseband signals 911.

In some embodiments that communicate OFDM signals or OFDMA signals, such as through baseband processor 608a, the transmit baseband processor 904 may be configured to generate OFDM or OFDMA signals as appropriate for transmission by performing an inverse fast Fourier transform (IFFT). The receive baseband processor 902 may be configured to process received OFDM signals or OFDMA signals by performing an FFT. In some embodiments, the receive baseband processor 902 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 6, in some embodiments, the antennas 601 (FIG. 6) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 601 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: receive, from an access point (AP), a trigger frame on a non-primary channel associated with a non-primary channel access (NPCA) mode of operation, the trigger frame comprising resource unit (RU) allocations for uplink transmissions; determine, based on the trigger frame, whether the device may be scheduled for an uplink transmission on the non-primary channel; transmit, using a resource unit allocated in the trigger frame, uplink data on the non-primary channel to the AP; and receive, from the AP, a block acknowledgment corresponding to the uplink transmission.

Example 2 may include the device of example 1 and/or some other example(s) herein, wherein the processing circuitry may be further configured to refrain from performing enhanced distributed channel access (EDCA) on the non-primary channel when the NPCA mode of operation may be enabled.

Example 3 may include the device of example 1 and/or some other example(s) herein, wherein the processing circuitry may be further configured to determine to enable or disable the use of NPCA based on a local control setting.

Example 4 may include the device of example 1 and/or some other example(s) herein, wherein the non-primary channel may be used for downlink transmissions unless the AP transmits a trigger frame to permit uplink access.

Example 5 may include the device of example 1 and/or some other example(s) herein, wherein the uplink data transmitted in the resource unit comprises latency-sensitive traffic.

Example 6 may include the device of example 1 and/or some other example(s) herein, wherein the trigger frame indicates a modulation and coding scheme (MCS) and number of spatial streams (NSS) associated with the allocated resource unit.

Example 7 may include the device of example 1 and/or some other example(s) herein, wherein the processing circuitry may be further configured to monitor an NPCA channel upon receipt of a wake-up signal or scheduled transmission indication from the AP.

Example 8 may include the device of example 1 and/or some other example(s) herein, wherein the processing circuitry may be further configured to provide buffer status information to the AP prior to receiving the trigger frame.

Example 9 may include the device of example 1 and/or some other example(s) herein, wherein the AP can selectively enable or disable the NPCA mode for individual associated STAs.

Example 10 may include a non-transitory computer-readable medium storing computer-executable instructions which when executed by one or more processors result in performing operations comprising: receiving, from an access point (AP), a trigger frame on a non-primary channel associated with a non-primary channel access (NPCA) mode of operation, the trigger frame comprising resource unit (RU) allocations for uplink transmissions; determining, based on the trigger frame, whether the device may be scheduled for an uplink transmission on the non-primary channel; transmitting, using a resource unit allocated in the trigger frame, uplink data on the non-primary channel to the AP; and receiving, from the AP, a block acknowledgment corresponding to the uplink transmission.

Example 11 may include the non-transitory computer-readable medium of example 10 and/or some other example(s) herein, wherein the operations further comprise refraining from performing enhanced distributed channel access (EDCA) on the non-primary channel when the NPCA mode of operation may be enabled.

Example 12 may include the non-transitory computer-readable medium of example 10 and/or some other example(s) herein, wherein the operations further comprise determining to enable or disable the use of NPCA based on a local control setting.

Example 13 may include the non-transitory computer-readable medium of example 10 and/or some other example(s) herein, wherein the non-primary channel may be used for downlink transmissions unless the AP transmits a trigger frame to permit uplink access.

Example 14 may include the non-transitory computer-readable medium of example 10 and/or some other example(s) herein, wherein the uplink data transmitted in the resource unit comprises latency-sensitive traffic.

Example 15 may include the non-transitory computer-readable medium of example 10 and/or some other example(s) herein, wherein the trigger frame indicates a modulation and coding scheme (MCS) and number of spatial streams (NSS) associated with the allocated resource unit.

Example 16 may include the non-transitory computer-readable medium of example 10 and/or some other example(s) herein, wherein the operations further comprise monitoring an NPCA channel upon receipt of a wake-up signal or scheduled transmission indication from the AP.

Example 17 may include the non-transitory computer-readable medium of example 10 and/or some other example(s) herein, wherein the operations further comprise providing buffer status information to the AP prior to receiving the trigger frame.

Example 18 may include the non-transitory computer-readable medium of example 10 and/or some other example(s) herein, wherein the AP can selectively enable or disable the NPCA mode for individual associated STAs.

Example 19 may include a method comprising: receiving, from an access point (AP), a trigger frame on a non-primary channel associated with a non-primary channel access (NPCA) mode of operation, the trigger frame comprising resource unit (RU) allocations for uplink transmissions; determining, based on the trigger frame, whether the device may be scheduled for an uplink transmission on the non-primary channel; transmitting, using a resource unit allocated in the trigger frame, uplink data on the non-primary channel to the AP; and receiving, from the AP, a block acknowledgment corresponding to the uplink transmission.

Example 20 may include the method of example 19 and/or some other example(s) herein, further comprising refraining from performing enhanced distributed channel access (EDCA) on the non-primary channel when the NPCA mode of operation may be enabled.

Example 21 may include the method of example 19 and/or some other example(s) herein, further comprising determining to enable or disable the use of NPCA based on a local control setting.

Example 22 may include the method of example 19 and/or some other example(s) herein, wherein the non-primary channel may be used for downlink transmissions unless the AP transmits a trigger frame to permit uplink access.

Example 23 may include the method of example 19 and/or some other example(s) herein, wherein the uplink data transmitted in the resource unit comprises latency-sensitive traffic.

Example 24 may include the method of example 19 and/or some other example(s) herein, wherein the trigger frame indicates a modulation and coding scheme (MCS) and number of spatial streams (NSS) associated with the allocated resource unit.

Example 25 may include the method of example 19 and/or some other example(s) herein, further comprising monitoring an NPCA channel upon receipt of a wake-up signal or scheduled transmission indication from the AP.

Example 26 may include the method of example 19 and/or some other example(s) herein, further comprising providing buffer status information to the AP prior to receiving the trigger frame.

Example 27 may include the method of example 19 and/or some other example(s) herein, wherein the AP can selectively enable or disable the NPCA mode for individual associated STAs.

Example 28 may include an apparatus comprising means for: receiving, from an access point (AP), a trigger frame on a non-primary channel associated with a non-primary channel access (NPCA) mode of operation, the trigger frame comprising resource unit (RU) allocations for uplink transmissions; determining, based on the trigger frame, whether the device may be scheduled for an uplink transmission on the non-primary channel; transmitting, using a resource unit allocated in the trigger frame, uplink data on the non-primary channel to the AP; and receiving, from the AP, a block acknowledgment corresponding to the uplink transmission.

Example 29 may include the apparatus of example 28 and/or some other example(s) herein, further comprising refraining from performing enhanced distributed channel access (EDCA) on the non-primary channel when the NPCA mode of operation may be enabled.

Example 30 may include the apparatus of example 28 and/or some other example(s) herein, further comprising determining to enable or disable the use of NPCA based on a local control setting.

Example 31 may include the apparatus of example 28 and/or some other example(s) herein, wherein the non-primary channel may be used for downlink transmissions unless the AP transmits a trigger frame to permit uplink access.

Example 32 may include the apparatus of example 28 and/or some other example(s) herein, wherein the uplink data transmitted in the resource unit comprises latency-sensitive traffic.

Example 33 may include the apparatus of example 28 and/or some other example(s) herein, wherein the trigger frame indicates a modulation and coding scheme (MCS) and number of spatial streams (NSS) associated with the allocated resource unit.

Example 34 may include the apparatus of example 28 and/or some other example(s) herein, further comprising monitoring an NPCA channel upon receipt of a wake-up signal or scheduled transmission indication from the AP.

Example 35 may include the apparatus of example 28 and/or some other example(s) herein, further comprising providing buffer status information to the AP prior to receiving the trigger frame.

Example 36 may include the apparatus of example 28 and/or some other example(s) herein, wherein the AP can selectively enable or disable the NPCA mode for individual associated STAs.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
receive, from an access point (AP), a trigger frame on a non-primary channel associated with a non-primary channel access (NPCA) mode of operation, the trigger frame comprising resource unit (RU) allocations for uplink transmissions;
determine, based on the trigger frame, whether the device is scheduled for an uplink transmission on the non-primary channel;
transmit, using a resource unit allocated in the trigger frame, uplink data on the non-primary channel to the AP; and
receive, from the AP, a block acknowledgment corresponding to the uplink transmission.

2. The device of claim 1, wherein the processing circuitry is further configured to refrain from performing enhanced distributed channel access (EDCA) on the non-primary channel when the NPCA mode of operation is enabled.

3. The device of claim 1, wherein the processing circuitry is further configured to determine to enable or disable the use of NPCA based on a local control setting.

4. The device of claim 1, wherein the non-primary channel is used for downlink transmissions unless the AP transmits a trigger frame to permit uplink access.

5. The device of claim 1, wherein the uplink data transmitted in the resource unit comprises latency-sensitive traffic.

6. The device of claim 1, wherein the trigger frame indicates a modulation and coding scheme (MCS) and number of spatial streams (NSS) associated with the allocated resource unit.

7. The device of claim 1, wherein the processing circuitry is further configured to monitor an NPCA channel upon receipt of a wake-up signal or scheduled transmission indication from the AP.

8. The device of claim 1, wherein the processing circuitry is further configured to provide buffer status information to the AP prior to receiving the trigger frame.

9. The device of claim 1, wherein the AP can selectively enable or disable the NPCA mode for individual associated STAs.

10. A non-transitory computer-readable medium storing computer-executable instructions which when executed by one or more processors result in performing operations comprising:
receiving, from an access point (AP), a trigger frame on a non-primary channel associated with a non-primary channel access (NPCA) mode of operation, the trigger frame comprising resource unit (RU) allocations for uplink transmissions;
determining, based on the trigger frame, whether the device is scheduled for an uplink transmission on the non-primary channel;
transmitting, using a resource unit allocated in the trigger frame, uplink data on the non-primary channel to the AP; and
receiving, from the AP, a block acknowledgment corresponding to the uplink transmission.

11. The non-transitory computer-readable medium of claim 10, wherein the operations further comprise refraining from performing enhanced distributed channel access (EDCA) on the non-primary channel when the NPCA mode of operation is enabled.

12. The non-transitory computer-readable medium of claim 10, wherein the operations further comprise determining to enable or disable the use of NPCA based on a local control setting.

13. The non-transitory computer-readable medium of claim 10, wherein the non-primary channel is used for downlink transmissions unless the AP transmits a trigger frame to permit uplink access.

14. The non-transitory computer-readable medium of claim 10, wherein the uplink data transmitted in the resource unit comprises latency-sensitive traffic.

15. The non-transitory computer-readable medium of claim 10, wherein the trigger frame indicates a modulation and coding scheme (MCS) and number of spatial streams (NSS) associated with the allocated resource unit.

16. The non-transitory computer-readable medium of claim 10, wherein the operations further comprise monitoring an NPCA channel upon receipt of a wake-up signal or scheduled transmission indication from the AP.

17. The non-transitory computer-readable medium of claim 10, wherein the operations further comprise providing buffer status information to the AP prior to receiving the trigger frame.

18. The non-transitory computer-readable medium of claim 10, wherein the AP can selectively enable or disable the NPCA mode for individual associated STAs.

19. A method comprising:
receiving, from an access point (AP), a trigger frame on a non-primary channel associated with a non-primary channel access (NPCA) mode of operation, the trigger frame comprising resource unit (RU) allocations for uplink transmissions;
determining, based on the trigger frame, whether the device is scheduled for an uplink transmission on the non-primary channel;
transmitting, using a resource unit allocated in the trigger frame, uplink data on the non-primary channel to the AP; and
receiving, from the AP, a block acknowledgment corresponding to the uplink transmission.

20. The method of claim 19, further comprising refraining from performing enhanced distributed channel access (EDCA) on the non-primary channel when the NPCA mode of operation is enabled.
